(19) United States
(12) Patent Application Publication
(10) Pub. No.: US 2015/0078533 A1
(43) Pub. Date: Mar. 19, 2015

(54) Cooled Stationary Anode for an X-Ray Tube

(71) Applicant: Quantum Technologie (Deutschland) GmbH, Puchheim (DE)

(72) Inventor: Ki CHAN, Wanchai (HK)

(21) Appl. No.: 14/551,703

(22) Filed: Nov. 24, 2014

Related U.S. Application Data
(63) Continuation of application No. PCT/EP2012/059766, filed on May 24, 2012.

(51) Int. Cl. H01J 35/12; H01J 35/06

(52) U.S. Cl. CPC H01J 35/12; H01J 35/06; H01J 2235/1291; H01J 2235/1262
USPC 378/142; 378/143

(57) ABSTRACT

An X-ray tube 10 with an anode 30 comprising at least a rod shaped body with a front wall having target area 32 as target for an electron beam 27 on its frontal side provides a high intensity of X-ray radiation if the anode 30 has at least one cavity extending to the front wall, the cavity having a coating 50 of at least one inorganic salt.

### PRIORITY CLAIM

This application is a continuation of pending International Application No. PCT/EP2012/059766 filed on 24 May 2012, which designates the United States and is incorporated by reference in its entirety.

### BACKGROUND OF THE INVENTION

1. Field of the Invention

The invention relates to a cooled stationary anode for an X-ray tube and to an X-ray tube.

2. Description of Relevant Art

X-ray tubes are of significant importance in medical imaging, in particular as X-ray sources for CT-scanners. Of course X-ray tubes are as well important in other technological fields as there are for example the determination of crystal structures (see e.g. Ashcroft Mermin, Solid State Physics, Saunders College Publishing, Chapt. 6) or the quick and reliable radiography which has become common use by customs authorities, to name only a few. These applications require a high radiated power for obtaining detailed information about the objects being subjected to an X-ray based analysis.

Briefly speaking X-rays are produced by an abrupt slowing down of previously accelerated electrons. To this end an X-ray tube comprises a cathode, often in form of a coiled filament. The filament is heated by applying a current to the filament to induce thermal emission of the electrons. The electrons are drawn of by an anode. The voltage between the anode and the cathode is typically of the order of a several kV, typically 25 to 150 kV, sometimes even up to 200 kV and more. The electrons are thus accelerated towards the anode up to several keV, until they are slowed down by inelastic scattering with the anode's atoms. Due to energy conservation a part of the electrons' kinetic energy is emitted as phonons, i.e. X-rays, having a continuous energy spectrum. The emission of the x-rays is as well referred to as Bremsstrahlung. Often, peaks are observed in radiation spectra of x-ray tubes. These peaks are due to a recombination of excited electrons of the atoms. The high kinetic energy of the electrons impinging the anode is unfortunately not only converted into short wavelength radiation, but as well into heat. Only a few percent of the electrical power provided to an X-ray tube is typically converted into X-rays, the remaining power is converted into heat. Efficient cooling of the X-ray tube, in particular of the anode is crucial for obtaining high X-ray intensities.

U.S. Pat. No. 6,807,382 B2 discloses an X-ray tube. The X-ray tube has as usual an evacuated compartment. In the compartment are a cathode for thermal emission of electrodes and a tungsten alloy anode as target for the electrons. The anode is disc shaped and has a circular peripheral area onto which the electrons are focused. The disc is mounted on a rotor shaft of a motor, thus in operation the focal point of the electron beam forms a circular focal track on the peripheral area. Attached to the rear side of the anode disc is a graphite back plate as heat sink. Heat is transferred from the anode to its back plate by heat pipes. The heat pipes are briefly speaking evacuated cylindrical metal shells, being partially filled with a working fluid like Sodium, Lithium, Zink or the like, i.e. fluids under operating conditions of the anode. In each metal shell is a capillary wick, being surrounded by a tube. The wick serves to transport the fluid to an evaporation end of the shell, which is in the proximity of the focal track. Thus, heat produced by the electrons impinging the focal track evaporates the liquid. The evaporated liquid (now in a gas state) condenses at the other end of the shell and thus transports heat from a region just behind the focal track towards the back plate.

U.S. Pat. No. 3,384,162 teaches an X-ray tube. The X-ray tube has as usual an anode. The anode is supported by a hollow tube, the latter being cooled by distilled water. The distilled water is drawn of a distilled water reservoir, cooled in a heat exchanger and fed to the hollow tube. There, distilled water is warmed and fed back to the reservoir. In the heat exchanger the distilled water is cooled using tap water. If the distilled water circuit breaks down, the hollow tube can be cooled using the tap water.

DE 10 2006 062 451 A1 relates to a micro-focus X-ray tube having as usual an anode. The anode is cooled by a liquid coolant. The coolant circulates in a conduit, such that the anode is in direct contact with the anode. The coolant is provided by an axial bore to the anode and subsequently drawn of via a coaxial conduit. The design of the conduit reduces the cooling effectiveness, because the common cylindrical wall separating the axial bore and the coaxial conduit acts as heat exchanger, preheating the coolant before it reaches the anode

WO 99/27557 as well relates to an X-ray tube with an anode tube. Electrons impinge on the upper surface of the anode tube. The anode tube constitutes a coaxial system of coolant supply and discharge conduits. In the anode tube there is an axial coolant supply to provide the coolant to the top of the anode. The space between the coolant supply and the anode tube's boundary is used as coaxial coolant discharge. This arrangement has the same drawback as the X-ray tube of DE 10 2006 062 451 A1, namely an unintended preheating of the coolant before reaching the anode.

The above summary of the related prior art is not intended to be applicant's admitted prior art, but to be perceived as a starting point of the invention.

### SUMMARY OF THE INVENTION

The invention is based on the observation, that the heat transfer mechanism for cooling the anode is complicated and expensive.

The problem to be solved by the invention is to provide a simple and thus less expensive heat transfer mechanism for cooling the anode of an X-ray tube.

The problem is solved by an anode for an X-ray tube as defined by claim 1. The dependent claims relate to improvements of the invention.

The problem is solved by providing an anode for an X-ray tube. The anode may comprise and/or resemble a rod, e.g. a circular rod. At a front surface of the anode may be a target area, for example an inlet or a layer made of tungsten or a tungsten alloy. The inlet or layer may be attached in front of a front wall of the rod. At least the front wall may be of a Molybdenum alloy.

The anode preferably has at least one cavity. At least a part of the inner surface of the anode may be coated by at least one inorganic salt or a composition of inorganic salts, as will be explained below in more detail. Alternatively one may say that at least a part of the cavity is coated by at least one inorganic salt. These inorganic salt(s) or the composition, respectively, form a coating with an excellent thermal conductivity on the inner surfaces of the anode. This provides an efficient and simple heat transfer from the region of the target surface, to some cooling device. The cavity may preferably be evacuated. Here, evacuated means that the cavity is essentially empty, it may still comprise some gas molecules, but at a lower pressure than ambient pressure.

Preferably, the cavity extends from a rear side of a front wall of the anode, i.e. from the area opposite the target area to a rear wall of the anode. The heat is produced in the material just behind the target area by electrons impinging the anode mostly due to Coulomb Interaction with electrons of the anode's atoms. As the preferably coated cavity extends to the rear side of the front wall, i.e. to an area being opposite to the target area, the heat can be conducted from its place of origin to some cooling device, e.g., a heat sink.

The cavity may have the form of cylindrical recess, being coaxially aligned with a longitudinal axis of the anode. The coating can be applied by filling a solution of the inorganic salt(s) (or the composition) into the cavity and to subsequently remove the solvent to thereby apply the coating. This procedure may be repeated multiple times. The solvent may be water, which can easily be removed, e.g., by heating the anode and/or reduction of the pressure in the cavity.

In a preferred embodiment, the anode comprises preferably at least as section of made of a Molybdenum alloy, as this enhances heat dissipation and durability of the anode.

The coating may preferably comprise inorganic oxides. A solution for coating the cavity may comprise a composition of the following constituents (variations in the composition of about 10% are acceptable):

| | |
|---|---|
| sodium peroxide | 2.705% |
| disodium oxide | 2.505% |
| Silicon | 1.6% |
| diboron trioxide | 0.505% |
| Titanium | 0.405% |
| copper oxide | 0.405% |
| cobalt oxide | 0.255% |
| beryllium oxide | 0.255% |
| water, distilled, conductivity or of similar purity | 89.256% |
| dirhodium trioxide | 1.6% |
| trimanganese tetraoxide | 0.255% |
| strontium carbonate | 0.255% |

Variations in the composition of about 10% are acceptable. This composition is only one possible composition. Examples for further compositions are for example described in U.S. Pat. Nos. 6,132,823, 6,911,231, 6,916,430, 6,811,720 and U.S. Publication No. 2005/0056807, which are incorporated by reference as if fully disclosed herein. The coating provided by applying the such compositions to the cavity acts as a thermally conductive material to provide at least an almost perfect homogenous distribution of the heat produced by the impinging electrons. The cavity may as well be evacuated as suggested in the above references. The thermally conductive material is an inorganic material that is a combination of oxides and one or more pure elemental species, particularly titanium and silicon.

The anode may of course be in included at least in part in an evacuated compartment of an X-ray tube. Such X-ray tube may comprise at least a cathode for emitting electrons. The cathode may be for example some tungsten filament, being configured for applying an electrical current. Additionally the X-ray tube may comprise means for focusing the electrons onto the target area of the anode and preferably means for supporting the anode. At least part of the anode and the cathode are enclosed in the evacuated compartment. The electron beam emitted by the cathode should preferably be focused to some point on the target area.

The compartment may be enclosed by a housing, forming a space between the compartment and the housing. A coolant may be circulated in the space. Appropriate means are well known to the skilled person. More preferably the coolant is circulated between a heat sink, or some other cooling device and the space.

The anode and the x-ray tube of the invention provide a much better cooling of the target area. Due to this increased cooling, there is no need for rotating the anode as it is described in the prior art, but however at least a similar X-ray intensity can be obtained. Therefore, the anode can be mounted in a fixed position relative to the cathode and a lot of technical difficulties are resolved, as it is rather complicated (and thus expensive) to cool and at the same time rotate an anode in an evacuated compartment.

### BRIEF DESCRIPTION OF THE DRAWINGS

In the following, the invention will be described by way of example, without limitation of the general inventive concept, on examples of embodiment and with reference to the drawings.

FIG. 1 shows a cross section of a simplified X-ray tube.

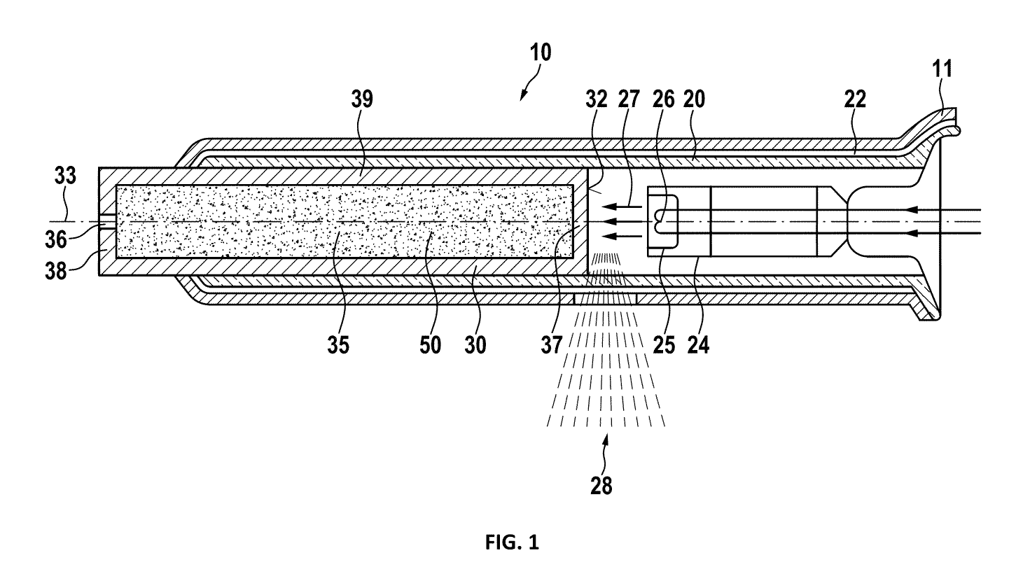

The X-ray tube 10 in FIG. 1 has a compartment 20, being formed by a compartment wall, e.g. of glass. The compartment 20 is enclosed in a housing 11, for example made of some metal. Between the compartment wall 20 and the housing 11 is a space 22, in which a coolant may circulate. Preferably the coolant circulates between the space 22 and a heat exchanger (not shown).

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENT

As already set out above, FIG. 1 shows a cross section of a simplified X-ray tube with a compartment 20, being formed by a compartment wall, e.g. of glass. The compartment 20 is enclosed in a housing 11, for example made of some metal. Between the compartment wall 20 and the housing 11 is a space 22, in which a coolant may circulate.

The compartment 20 is evacuated and encloses a cathode assembly 24, having a filament cathode 26, being connected to a power supply. By applying electrical power to the cathode 26, the cathode 26 may be heated to obtain thermal emission of electrons.

The compartment 20 as well encloses part of an anode 30. The anode 30 resembles a cylindrical rod with a cylinder axis 33. The anode 30 has a frontal side facing towards the cathode assembly 24. On the frontal facing side of the disc is a peripheral target area 32 for electrons 27 being emitted by the cathode 26 and subsequently accelerated by a voltage between cathode 26 an the anode 30. The target area 32 may be a layer of tungsten or a tungsten alloy. The layer may be attached to the front end of front wall 37 of the rod, which may be of a Molybdenum alloy.

The anode has a cavity 35 extending coaxially along axis 33, accordingly the anode has a front wall 37 and a rear wall 38, which are connected by a tube like section 39. The anode has an opening 36 at its rear end. Via opening 36 a solution for applying the coating 50 can be inserted. Subsequently the solvent can be removed and the opening can be sealed. The cavity can be evacuated.

Focusing means 25 focus the electrons 27 on a spot on the target area 32. Thus, an electron beam 27 is focused on the target area 32.

At the inner surface of the anode 30 is a coating 50 comprising a composition of inorganic salts and elements, e.g., those listed above in Table 1. The coating can be applied to the anode by filling a solution of the inorganic salt(s) and elements via an opening 36 of the cavity 35 in the rear wall 38 of the anode in the cavity 35. Subsequently the solvent, which is in the example of the Table 1 water, can be removed from the cavity. The inorganic salts and elements remain as a coating in on the inner side of the front wall 37, rear wall 38 and the tube section 39. Preferably the anode is rotated and/or pivoted while removing the solvent, to thereby obtain a homogeneous coating 50.

Preferably the inner surface is fully coated. The coating 50 has an excellent thermal conductivity and provides for an excellent dissipation of heat away from the target area 32 towards a rear end of the anode. The rear end of the anode is preferably cooled as known by the skilled person.

In operation an electron beam 27 is emitted by the cathode 26 and focused on the target area 32. Some of the electrons of electron beam 27 are slowed down due to Coulomb Interaction, e.g., with cores of atoms of the anode 30 and thus emit X-ray Bremsstrahlung. Most of the electrons, however, interact with electrons of the atoms of the front wall; thus their kinetic energy is converted into heat. This heat dissipates towards the inner cavity surface, and is thus transferred to the coating 50. Coating 50 participates and thereby enhances conduction of the heat away from the target area to the rear end of the anode, which is connected to some cooling device (not shown).

It will be appreciated to those skilled in the art having the benefit of this disclosure that this invention is believed to provide an enhanced X-ray tube. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

10 X-ray tube
11 housing
20 compartment/compartment wall
22 space, e.g. for coolant
24 cathode assembly
26 cathode
27 electron beam
28 X-rays
30 anode
32 target surface/target area
33 longitudinal axis of anode 30
35 cavity
36 opening of cavity
37 front wall
38 rear wall
39 tube section/tubular section
50 coating

1. Anode for an X-ray tube, the anode comprising:
a rod shaped body with a front wall having target area on a front side of the front wall as target for an electron beam,
wherein the anode has at least one evacuated cavity extending to the front wall, the cavity having a coating of at least one inorganic salt.

2. The anode of claim 1
wherein the cavity comprises at least a recess extending from a rear wall to the front wall of the anode.

3. The anode of claim 1
wherein at least part of the front wall comprises Molydenum alloy.

4. The anode of claim 1
wherein the coating comprises at least one the members of the group consisting of Sodium Peroxide, Disodium Oxide, Silicon, Diboron Trioxide, Titanium, Copper Oxide, Cobalt Oxide, Beryllium Oxide, Dirhodium Trioxide, Trimanganese Tetraoxide and Strontium Carbonate.

5. X-ray tube, comprising:
a wall defining an evacuated compartment that encloses at least a portion of each of:
a cathode configured to emit electrons,
an anode with a target area, and
means for focusing the electrons onto the target area,
wherein the anode has at least one cavity extending to the front wall, the cavity having a coating of at least one inorganic salt.

6. X-ray tube of claim 5
wherein the anode is supported by the housing and stationary relative to the compartment.

7. X-ray tube of claim 5
wherein the wall is enclosed by a housing, forming a space between the compartment and the housing.

8. X-ray tube of claim 7,
wherein the X-ray tube is coupled to a source of coolant configured to circulate a coolant in the space between the compartment and the housing.

9. X-ray tube, comprising:
a wall defining an evacuated compartment that encloses at least a portion of each of:
a cathode configured to emitt electrons,
an anode with a target area, and
a ring configured to focus the electrons onto the target area,
wherein the anode has at least one cavity extending to the front wall, the cavity having a coating of at least one inorganic salt.

10. X-ray tube of claim 9
wherein the anode is supported by the housing and stationary relative to the compartment.

11. X-ray tube of claim 10
wherein the wall is enclosed by a housing, forming a space between the compartment and the housing.

12. X-ray tube of claim 11,
wherein the X-ray tube is coupled to a source of coolant configured to circulate a coolant in the space between the compartment and the housing.
